(19) United States
(12) Patent Application Publication
(10) Pub. No.: US 2014/0258965 A1
(43) Pub. Date: Sep. 11, 2014

(54) ORGANIC PROTOTYPING SYSTEM AND ASSOCIATED METHODS

(71) Applicant: Catherine Ann Downey, Atlanta, GA (US)

(72) Inventor: Catherine Ann Downey, Atlanta, GA (US)

(21) Appl. No.: 14/202,827

(22) Filed: Mar. 10, 2014

Related U.S. Application Data
(60) Provisional application No. 61/775,366, filed on Mar. 8, 2013.

(51) Int. Cl. G06F 9/44

(52) U.S. Cl. CPC G06F 8/10
USPC 717/100

(57) ABSTRACT

Systems and methods for developing software based training courses are disclosed. In one embodiment a method includes: outlining organic prototype requirements; receiving content from client; setting module objectives; creating modules; visualizing data; pricing media production; producing content/media; creating initial organic prototype; incorporating creative/visual approach; deciding on number of modules; designing software architecture; walking through the training course walkthrough; beta testing, final review; and deploying the organic prototype's final stage to client.

### CROSS-REFERENCE TO RELATED APPLICATION(S)

The present non-provisional patent application claims the benefit of priority of U.S. Provisional Patent Application No. 61/775,366 which is entitled “ORGANIC PROTOTYPING METHOD”, which was filed on Mar. 8, 2013, and which is incorporated in full by reference herein.

### FIELD OF THE INVENTION

The technology described herein relates generally to software development systems and methods. In particular, the technology described herein pertains to a process for designing and developing a training course responsively as a client decides upon the requirements and content.

### BACKGROUND OF THE INVENTION

Software development (also known as application development, software design, designing software, software application development, enterprise application development, or platform development) is the development of a software product. The term software development may be used to refer to the activity of computer programming, which is the process of writing and maintaining the source code, but in a broader sense of the term it includes all that is involved between the conception of the desired software through to the final manifestation of the software, ideally in a planned and structured process. Therefore, software development may include research, new development, prototyping, modification, reuse, re-engineering, maintenance, or any other activities that result in software products.

Software can be developed for a variety of purposes. By way of example, software can be developed to meet specific needs of a specific client/business (the case with custom software). Also, by way of example, software can be developed to meet a perceived need of some set of potential users (the case with commercial and open source software). Further, by way of example, software can be developed for personal use (e.g. a scientist may write software to automate a mundane task).

Embedded software development, i.e., the development of embedded software, such as that used for controlling consumer products, requires the development process to be integrated with the development of the controlled physical product.

The need for better quality control of the software development process has given rise to the discipline of software engineering, which aims to apply the systematic approach exemplified in the engineering paradigm to the process of software development.

There are several different approaches to software development, much like the various views of political parties toward governing a country. Some take a more structured, engineering-based approach to developing business solutions, whereas others may take a more incremental approach, where software evolves as it is developed piece-by-piece. Most methodologies share some combination of the following stages of software development: 1) Analyzing the problem; 2) Market research; 3) Gathering requirements for the proposed business solution; 4) Devising a plan or design for the software-based solution; 5) Implementation (coding) of the software; 6) Testing the software; 7) Deployment; and 8) Maintenance and bug fixing.

These stages are often referred to collectively as the Software Development Life Cycle, or SDLC. Different approaches to software development may carry out these stages in different orders, or devote more or less time to different stages. The level of detail of the documentation produced at each stage of software development may also vary.

These stages may also be carried out in turn (a “waterfall” based approach), or they may be repeated over various cycles or iterations (a more “extreme” approach). The more extreme approach usually involves less time spent on planning and documentation, and more time spent on coding and development of automated tests.

More extreme approaches also promote continuous testing throughout the development lifecycle, as well as having a working (or bug-free) product at all times. More structured or “waterfall” based approaches attempt to assess the majority of risks and develop a detailed plan for the software before implementation (coding) begins, and avoid significant design changes and re-coding in later stages of the software development lifecycle planning.

There are significant advantages and disadvantages to the various methodologies, and the best approach to solving a problem using software will often depend on the type of problem. If the problem is well understood and a solution can be effectively planned out ahead of time, the more “waterfall” based approach may work the best. If, on the other hand, the problem is unique (at least to the development team) and the structure of the software solution cannot be easily envisioned, then a more “extreme” incremental approach may work best.

A software development process is a structure imposed on the development of a software product. Synonyms include software life cycle and software process. There are several models for such processes, each describing approaches to a variety of tasks or activities that take place during the process.

A recurring problem in software development pertains to “scope creep”, that is, additional requirements and/or changing requirements by the person or persons providing the parameters/objectives/output desired for the software. This is especially true for the design and development of software aided training courses. There is an industry need for rapid deployment of training courses, rapid implementation of client changes and online real-time monitoring of the training course development by the client.

Related published patent applications known in the background art include the following:

U.S. Published Patent Application No. 2003/0040949, filed by inventor Baccaro et al. and published on Feb. 27, 2003, discloses a method and system for developing effective training content. The system provides training content that observes a learning-centered principal, a results-oriented principal and an engagement principal. One or more course development phases are performed which ensure that the principals are observed. The development phases include a needs analysis phase, a project kickoff phase, an outlining phase, a training course design phase, a design analysis phase, an activity development phase, an activity analysis phase, a production scheduling phase, a storyboard development phase, a content development completion phase, a storyboard completion phase, review-edit phases, a key test phase, and a training course assembly phase. Further, the training content is delivered via the Internet, an Intranet, in a computer-readable medium or in printed form.

The foregoing published patent application and non-patent information reflect the state of the art of which the inventor is aware and is tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

The technology described herein pertains to a process for developing software based training courses with the following characteristics: 1) Rapid deployment; 2) Rapid implementation of client course content updates and changes; 3) Constant quality assurance (QA) testing conducted by both the client and the developer; 4) Active monitoring of the progress of the training course via an online prototype; and 5) Interactive responsive feedback from the client.

In one exemplary embodiment, the technology described herein provides a method for designing and developing a training course responsively as a client makes decisions on requirements and content. The method includes: outlining organic prototype requirements based upon goals a client would like to achieve, thereby setting goals of an organic prototype; receiving client content which client wants included in the organic prototype; setting module objectives, thereby creating an objectives list based upon goals defined in the organic prototype; creating modules, after the modules objectives are set; visualizing data, after the modules are determined; pricing media production, thereby calculating expenses based on the choices of data visualization; producing content and media for the organic prototype; and creating the organic prototype.

In at least one embodiment, the method also includes: incorporating a creative and visual approach as features are added and removed from the organic prototype; determining a number of modules to be created; and designing a software architecture to facilitate the organic prototype.

In at least one embodiment, the method further includes: walking through the organic prototype, with a developer, for the client; beta testing the organic prototype; reviewing, by the client and developer, the organic prototype, in a latest version form; and deploying a final prototype to the client, if the reviewing step is satisfactory.

In at least one embodiment, the method also includes repeating, as determined necessary, the steps of walking through, beta testing, reviewing, and deploying, thereby updating and improving the organic prototype.

In at least one embodiment, the method step for outlining organic prototype requirements based upon goals a client would like to achieve, thereby setting goals of an organic prototype also includes: delivering a message to employees within a company or persons within an organization; educating a group persons on a new policy; and providing training to new employees or persons.

In at least one embodiment, the method step for receiving client content which client wants included in the organic prototype further includes researching and accumulating relative content including one or more taken from the group consisting of: images, documents, policies, tutorials, organizational charts, diagrams, wireframes, surveys, and videos.

In at least one embodiment, the method step for visualizing data also includes: dividing content into appropriate modules; and collaborating and determining a preferred medium in which to present the content of the module.

In at least one embodiment, the method step for pricing media production, thereby calculating expenses based on the choices of data visualization further includes: estimating hours for labor; estimating travel expenses; and estimating equipment rental and expenses.

In at least one embodiment, the method for producing content and media for the organic prototype also includes: producing written content; and producing video content.

In another exemplary embodiment, the technology described herein provides a computer readable storage medium encoded with programming for designing and developing a training course responsively as a client makes decisions on requirements and content. The computer readable storage medium encoded with programming configured to: outline a organic prototype requirements based upon goals a client would like to achieve, thereby setting goals of an organic prototype; receive client content which client wants included in the organic prototype; set module objectives, thereby creating an objectives list based upon goals defined in the organic prototype; create modules, after the modules objectives are set; visual data, after the modules are determined; price media production, thereby calculating expenses based on the choices of data visualization; produce content and media for the organic prototype; and create the organic prototype.

In at least one embodiment, the programming in the computer readable storage medium is also configured to: incorporate a creative and visual approach as features are added and removed from the organic prototype; determine a number of modules to be created; and design a software architecture to facilitate the organic prototype.

In at least one embodiment, the programming in the computer readable storage medium is further configured to: walk through the organic prototype, with a developer, for the client; beta test the organic prototype; review, by the client and developer, the organic prototype, in a latest version form; and deploy a final prototype to the client, if the reviewing step is satisfactory.

In at least one embodiment, the programming in the computer readable storage medium is also configured to repeat, as determined necessary, the steps of walking through, beta testing, reviewing, and deploying, thereby updating and improving the organic prototype.

In at least one embodiment, the programming in the computer readable storage medium is further configured to: deliver a message to employees within a company or persons within an organization; educate a group persons on a new policy; and provide training to new employees or persons.

In at least one embodiment, the programming in the computer readable storage medium is also configured to: research and accumulate relative content including one or more taken from the group consisting of: images, documents, policies, tutorials, organizational charts, diagrams, wireframes, surveys, and videos; divide content into appropriate modules; collaborate and determine a preferred medium in which to present the content of the module; estimate hours for labor; estimate travel expenses; and estimate equipment rental and expenses.

In yet another exemplary embodiment, the technology described herein provides a system for designing and developing a training course responsively as a client makes decisions on requirements and content. The system includes: a user interface through which members access the system across a network and for designing and developing a training course responsively as a client makes decisions on requirements and content; a secure database server consisting of a plurality of database modules for the storage of data pertaining to development of organic prototypes; wherein the system is configured to: outline a organic prototype requirements based upon goals a client would like to achieve, thereby setting goals of an organic prototype; receive client content which client wants included in the organic prototype; set module objectives, thereby creating an objectives list based upon goals defined in the organic prototype; create modules, after the modules objectives are set; visual data, after the modules are determined; price media production, thereby calculating expenses based on the choices of data visualization; produce content and media for the organic prototype; and create the organic prototype.

In at least one embodiment of the system, the system is further configured to: incorporate a creative and visual approach as features are added and removed from the organic prototype; determine a number of modules to be created; and design a software architecture to facilitate the organic prototype.

In at least one embodiment of the system, the system is also configured to: walk through the organic prototype, with a developer, for the client; beta test the organic prototype; review, by the client and developer, the organic prototype, in a latest version form; and deploy a final prototype to the client, if the reviewing step is satisfactory.

In at least one embodiment of the system, the system is further configured to repeat, as determined necessary, the steps of walking through, beta testing, reviewing, and deploying, thereby updating and improving the organic prototype.

In at least one embodiment of the system, the system is further configured to: deliver a message to employees within a company or persons within an organization; educate a group persons on a new policy; provide training to new employees or persons; research and accumulate relative content including one or more taken from the group consisting of: images, documents, policies, tutorials, organizational charts, diagrams, wireframes, surveys, and videos; divide content into appropriate modules; collaborate and determining a preferred medium in which to present the content of the module; estimate hours for labor; estimate travel expenses; and estimate equipment rental and expenses.

Thus, the technology described herein includes a useful, novel, and unobvious system and associated methods for the designing and developing a training course responsively as a client makes decisions on requirements and content.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the technology is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the technology described herein. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein will be better understood by reading the detailed description of the invention with reference to the accompanying drawing figures, in which like reference numerals denote similar structure and refer to like elements and/or method steps, respectively, throughout, and in which:

FIG. 1 is a flow diagram, illustrating, in particular a training course development process, e.g. organic prototyping development, according to an embodiment of the technology described herein.

FIG. 2 is a schematic diagram illustrating a system architecture for designing and developing a training course responsively as a client makes decisions on requirements and content, according to an embodiment of the technology described herein; and

FIG. 3 is a block diagram illustrating the general components of a computer according to an exemplary embodiment of the technology, and upon which any one or more of the method steps described within are implemented in various embodiments.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a system and processes for developing software based training courses. The system and processes have been created with the following characteristics and objectives: 1) Rapid deployment; 2) Rapid implementation of client course content updates and changes; 3) Constant quality assurance (QA) testing conducted by both the client and the developer; 4) Active monitoring of the progress of the training course via an online prototype; and 5) Interactive responsive feedback from the client.

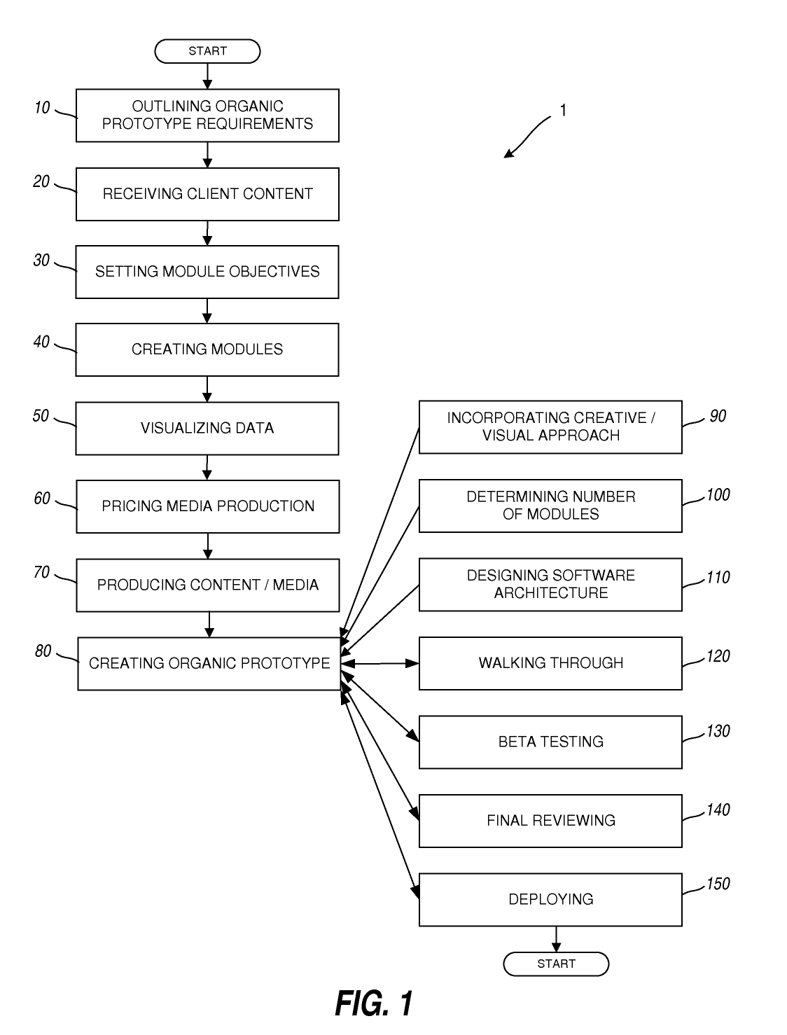

Referring now to FIG. 1, illustrated therein is a creation process for organic prototyping development. FIG. 1 is a flowchart diagram 1 illustrating, in particular an interactive training course development process, e.g. organic prototyping development.

In an exemplary embodiment the technology described herein includes the method and process steps of outlining organic prototype requirements 10, receiving client content 20, setting module objectives 30, creating modules 40, visualizing data 50, pricing media production 60, producing content/media 70, creating organic prototype 80, incorporating creative/visual approach 90, deciding on number of modules 100, designing software architecture 110, conducting walkthrough 120, beta testing 130, final review 140 and deploying system 150.

In step 10, Outlining Organic Prototype Requirements, a client outlines the desired goals they would like to achieve. By way of example, those goals can be many things including, but not limited to: 1) delivering a message to employees within a company; 2) educating a group of people on new policies; 3) providing training to new employees; and 4) trying to take a complex subject matter and present the content in an easily received way. It will be apparent of one of ordinary skill in this art, upon reading this disclosure, that the goals may vary based upon many factors, such as for example, the industry or business in which the clients operates.

After the goals of the organic prototype have been set, the features required to fulfill those goals can be chosen. These features can range from the graphics of the prototype to the functionality of the architecture of the application.

In step 20, Receiving Client Content, the client delivers all of the relative content that they have either researched or accumulated that they would like to include into their prototype. By way of example, this content may include, but is not limited to 1) images; 2) documents; 3) policies; 4) tutorials; 5) organization charts; 6) diagrams, 7) wireframes; 8) surveys; and 9) videos. It will be apparent of one of ordinary skill in this art, upon reading this disclosure, that the content may vary based upon many factors, such as for example, the industry or business in which the clients operates.

In step 30, Setting Module Objectives, a list of objectives is created based on the prototype's goals and the content submitted by the client. The module objectives are the expectations of the target audience or target user after using the organic prototype's finished product. The length of the objective list is determined by the difficulty of each objective. A longer list may be required for information content that is more complex or abundant.

In step 40, Creating Modules, and after the objectives are formed in step 30, modules can be created around a single or multiple objectives. Creating a module around multiple objectives allows for similar objectives to share the content. Multiple objectives in a single module will allow for a more efficient prototype. Additionally, multiple objectives in a single module will avoid redundant content.

In step 50, Visualizing Data, and after the modules are determined in step 40, the content can be divided up into their appropriate modules. A collaborative effort is then put forth in determining the most efficient way in presenting the content of module. The visualization of this data can vary by mediums, but is chosen based on its effectiveness with the target user. By way of example, these mediums include, but are not limited to: 1) video; 2) graphics; 3) charts; 4) graphs; 5) interactive tools; 6) audio clips; and 7) instructional games. It will be apparent of one of ordinary skill in this art, upon reading this disclosure, that the choice of one or more medium may vary based upon many factors, such as for example, the industry or business in which the clients operates.

In step 60, Pricing Media Production, the expenses are now calculated based on the choices of data visualization in step 50. By way of example, the expenses can include, but are not limited to: 1) estimated total labor hours of all involved employees; 2) travel expenses, and equipment rental.

In step 70, Producing Content/Media, involves creating every possible media asset for the organic prototype. By way of example, the content and/or media can include, but is not limited to: 1) video; 2) writing; 3) graphics; and 4) interactive games.

Producing written content involves structuring one or more outlines and writing unique material based upon the content provided by the client.

Video production requires a schedule planned, scripts written, shoot locations determined, travel plans made, hotel rentals made, equipment rented, capturing video, capturing sounds, importing video into software, editing video, editing audio, video graphics created, graphics inserted, video quality reviews, video exported to correct format. In addition, all talent and appropriate crewmembers required must be interviewed and hired. These crewmembers may include director, producer, writer, editor, audio technician, gaffer, camera operator, director of photography, graphic artist, actors, voice over artist, and animator.

The graphics production process involves, creating wireframes, layouts, picking color themes, utilizing the correct software, exporting multiple formats, and delivering to the programmer to be implemented into the prototype.

In step 80, Creating Organic Prototype, here the initial architecture of the organic prototype is designed and developed in order to fulfill the requirements of its outline. This early stage of programming will allow media assets (video, graphics, and text) to be included into the organic prototype.

In step 90, Incorporating Creative/Visual Approach, as features are added and removed from the prototype, the appearance of the prototype will be constantly changing. Incorporating the creative approach to the organic prototype ensures a consistent strong design stays in place. By way of example, changes to the prototype may include: 1) new features added; 2) graphics changed; 3) usability update; and 4) media asset replacement.

In step 100, Deciding on Number of Modules, the organic prototype's content may change at any time. When a content change or update takes place, the number of modules can be altered to keep the integrity of the entire prototype. Entire modules of the prototype may be removed, added, divided, or merged if it is deemed necessary.

In step 110, Designing Software Architecture, this process phase represents the task of concurrently implementing newly requested features, while still actively developing the prototype. If any requests for changes are made to the prototype's usability, functionality, layout, or embedded assets, they must be made in this phase.

In step 120, Walkthrough, a walkthrough is conducted. A walkthrough is a form of review wherein a user is guided through the organic prototype specifically by a developer. When a user is given a walkthrough, the developers can explain the benefits of the organic prototype's features. Walkthroughs can take place after art changes, number of module changes, usability changes, application bug removal, or functionality updates.

In step 130, Beta Testing, beta testing is conducted. Beta testing requires a larger group of users, which have little to no experience with the prototype. This user base will be tasked with using the prototype in the same manner as its target audience. This user base will report to the developer any difficulties in usability, crashes of the software, typos, and general software bugs. These logs will be reviewed and changes will be made accordingly, in order to have the most stable prototype as an end product deliverable.

In step 140, Final Review, a final review is conducted. The final review involves both the client and the developer. The developer makes the latest version of the organic prototype available to the client for use. This differs from a walkthrough, because the client does not have the developer during the walkthrough to guide them through the prototype. The client either approves of the current prototype or will request changes to be made.

If changes are requested, they will be reviewed, implemented, and sent through beta testing. After the changes are sent through beta testing, they will be sent for a final review again. This process can be repeated as necessary.

In step 150, Deploying, delivery is conducted. After the client's final approval, deployment involves the delivery of the final prototype to the client. The final prototype can be delivered in multiple ways that include, but not limited to: a physical DVD via mail, a digital format via email, or uploaded to a server for the target audience to access.

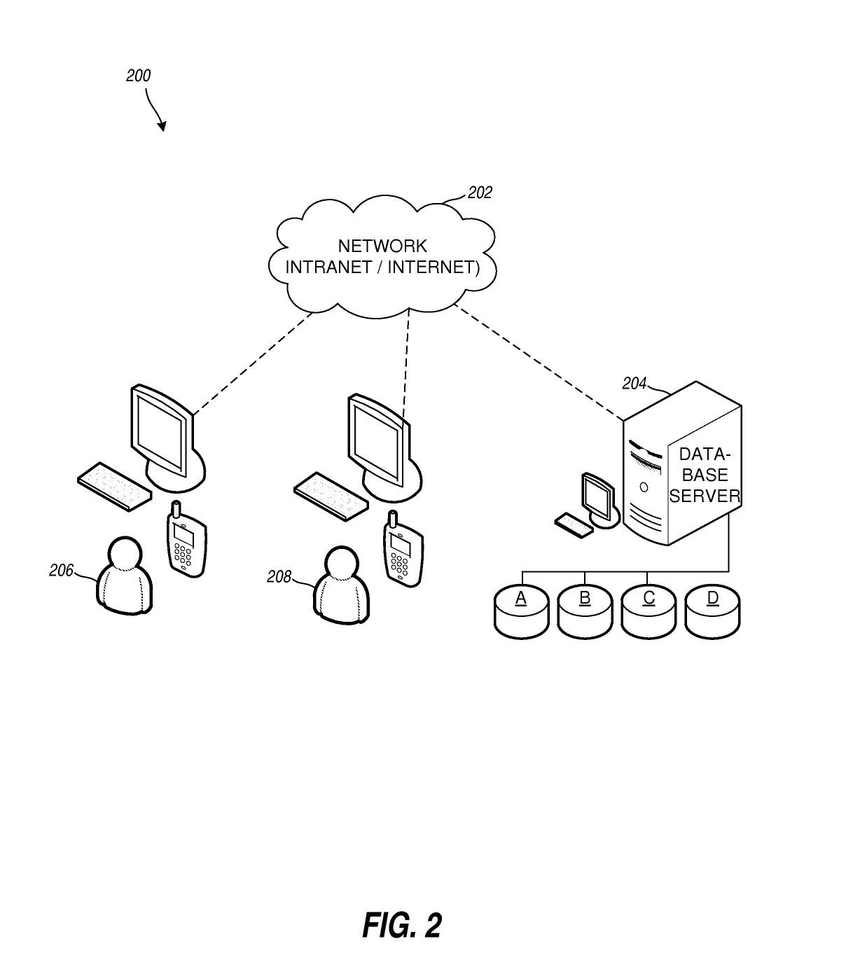

Referring now to the FIG. 2, illustrated therein is a schematic diagram 200 illustrating a system architecture for designing and developing a training course responsively as a client makes decisions on requirements and content.

In at least one embodiment, client 206 and developer 208 are in communications over a network 202. Network 202 includes internet and or intranet networks in various embodiments. Such communications includes access to database server 204, or like servers, for the development of organic prototypes for the client 206. Additionally, such communications can include use of devices such as computers, smart phones, routers, and like communications devices.

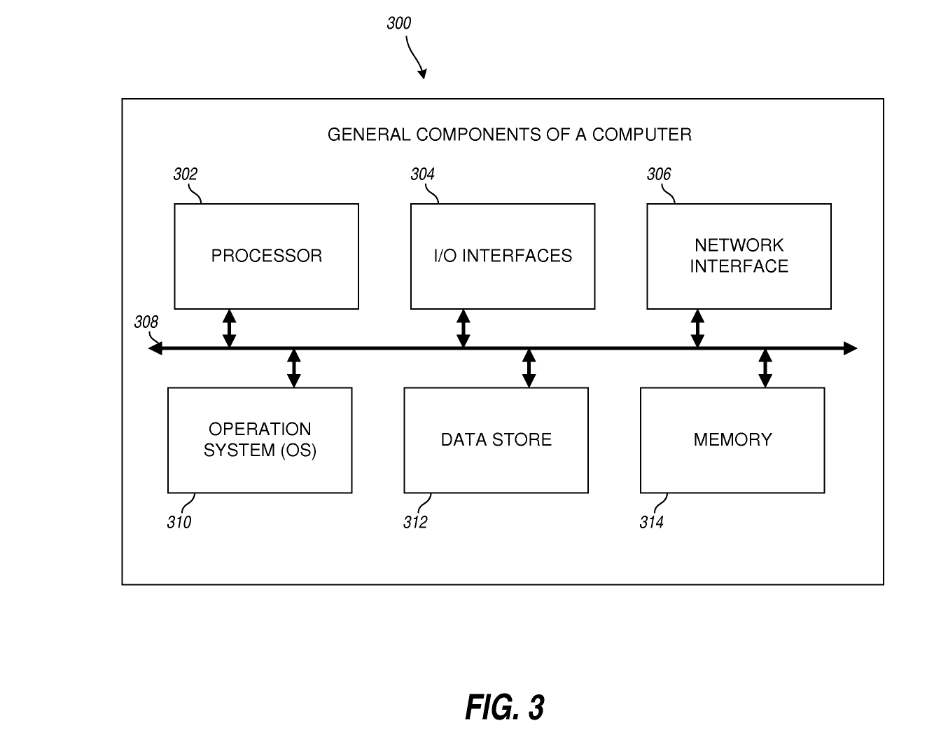

Referring now to FIG. 3, a block diagram 300 illustrating the general components of a computer is shown. Any one or more of the computers, laptops, servers, databases, and the like, disclosed above, may be implemented with such hardware and software components. The computer 300 can be a digital/virtual computer that, in terms of hardware architecture, generally includes a processor 302, input/output (I/O) interfaces 304, network interfaces 306, an operating system (O/S) 310, a data store 312, and a memory 314. The components (302, 304, 306, 310, 312, and 314) are communicatively coupled via a local interface 308. The local interface 308 can be, for example but not limited to, one or more buses or other wired or wireless connections, as is known in the art. The local interface 308 can have additional elements, which are omitted for simplicity, such as controllers, buffers (caches), drivers, among many others, to enable communications. Further, the local interface 308 can include address, control, and/or data connections to enable appropriate communications among the aforementioned components. The general operation of a computer comprising these elements is well known in the art. In at least one embodiment, one or more aspects of the method are hosted in the network cloud, in one or more of a cloud computing model, nanotechnology model, or biotechnology model.

The processor 302 is a hardware device for executing software instructions. The processor 302 can be any custom made or commercially available processor, a central processing unit (CPU), an auxiliary processor among several processors associated with the computer 300, a semiconductor-based microprocessor (in the form of a microchip or chip set), or generally any device for executing software instructions. When the computer 300 is in operation, the processor 302 is configured to execute software stored within the memory 314, to communicate data to and from the memory 314, and to generally control operations of the computer 300 pursuant to the software instructions.

The I/O interfaces 304 can be used to receive user input from and/or for providing system output to one or more devices or components. User input can be provided via, for example, a keyboard and/or a mouse. System output can be provided via a display device and a printer. I/O interfaces 304 can include, for example but not limited to, a serial port, a parallel port, a small computer system interface (SCSI), an infrared (IR) interface, a radio frequency (RF) interface, and/or a universal serial bus (USB) interface.

The network interfaces 306 can be used to enable the computer 300 to communicate on a network. For example, the computer 300 can utilize the network interfaces 308 to communicate via the internet to other computers or servers for software updates, technical support, etc. The network interfaces 308 can include, for example, an Ethernet card (e.g., 10 BaseT, Fast Ethernet, Gigabit Ethernet) or a wireless local area network (WLAN) card (e.g., 802.11a/b/g). The network interfaces 308 can include address, control, and/or data connections to enable appropriate communications on the network.

A data store 312 can be used to store data, such as information regarding positions entered in a requisition. The data store 312 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 312 can incorporate electronic, magnetic, optical, and/or other types of storage media. In one example, the data store 312 can be located internal to the computer 300 such as, for example, an internal hard drive connected to the local interface 308 in the computer 300. Additionally in another embodiment, the data store can be located external to the computer 300 such as, for example, an external hard drive connected to the I/O interfaces 304 (e.g., SCSI or USB connection). Finally in a third embodiment, the data store may be connected to the computer 300 through a network, such as, for example, a network attached file server.

The memory 314 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 314 may incorporate electronic, magnetic, optical, and/or other types of storage media. Note that the memory 314 can have a distributed architecture, where various components are situated remotely from one another, but can be accessed by the processor 302.

The software in memory 314 can include one or more software programs, each of which includes an ordered listing of executable instructions for implementing logical functions. The operating system 310 essentially controls the execution of other computer programs, such as the interactive toolkit for sourcing valuation, and provides scheduling, input-output control, file and data management, memory management, and communication control and related services. The operating system 310 can be any of Windows Server, Windows Azure, Windows NT, Windows 2000, Windows XP, Windows Vista, Windows 7, Windows 8 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C.), SendGrid, Amazon, Android, or other like operating system with similar functionality.

In an exemplary embodiment of the technology described herein, one or more computers 300 are configured to perform one or more elements of flowchart 1, as depicted in FIG. 1.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the disclosed technology.

What is claimed is:

1. A method for designing and developing a training course responsively as a client makes decisions on requirements and content, the method comprising:
outlining organic prototype requirements based upon goals a client would like to achieve, thereby setting goals of an organic prototype;
receiving client content which client wants included in the organic prototype;
setting module objectives, thereby creating an objectives list based upon goals defined in the organic prototype;
creating modules, after the modules objectives are set;
visualizing data, after the modules are determined;
pricing media production, thereby calculating expenses based on the choices of data visualization;
producing content and media for the organic prototype; and
creating the organic prototype.

2. The method of claim 1, further comprising:
incorporating a creative and visual approach as features are added and removed from the organic prototype;
determining a number of modules to be created; and
designing a software architecture to facilitate the organic prototype.

3. The method of claim 2, further comprising:
walking through the organic prototype, with a developer, for the client;
beta testing the organic prototype;
reviewing, by the client and developer, the organic prototype, in a latest version form; and
deploying a final prototype to the client, if the reviewing step is satisfactory.

4. The method of claim 3, further comprising:
repeating, as determined necessary, the steps of walking through, beta testing, reviewing, and deploying, thereby updating and improving the organic prototype.

5. The method of claim 1, wherein the method step for outlining organic prototype requirements based upon goals a client would like to achieve, thereby setting goals of an organic prototype further comprises:
delivering a message to employees within a company or persons within an organization;
educating a group persons on a new policy; and
providing training to new employees or persons.

6. The method of claim 1, wherein the method step for receiving client content which client wants included in the organic prototype further comprises:
researching and accumulating relative content including one or more taken from the group consisting of: images, documents, policies, tutorials, organizational charts, diagrams, wireframes, surveys, and videos.

7. The method of claim 1, wherein the method step for visualizing data further comprises:
dividing content into appropriate modules; and
collaborating and determining a preferred medium in which to present the content of the module.

8. The method of claim 1, wherein the method step for pricing media production, thereby calculating expenses based on the choices of data visualization further comprises:
estimating hours for labor;
estimating travel expenses; and
estimating equipment rental and expenses.

9. The method of claim 1, wherein the method step for producing content and media for the organic prototype further comprises:
producing written content; and
producing video content.

10. A computer readable storage medium encoded with programming for implementing a system for designing and developing a training course responsively as a client makes decisions on requirements and content, the computer readable storage medium encoded with programming configured to:
outline a organic prototype requirements based upon goals a client would like to achieve, thereby setting goals of an organic prototype;
receive client content which client wants included in the organic prototype;
set module objectives, thereby creating an objectives list based upon goals defined in the organic prototype;
create modules, after the modules objectives are set;
visual data, after the modules are determined;
price media production, thereby calculating expenses based on the choices of data visualization;
produce content and media for the organic prototype; and
create the organic prototype.

11. The computer readable storage medium of claim 9, wherein the programming is further configured to:
incorporate a creative and visual approach as features are added and removed from the organic prototype;
determine a number of modules to be created; and
design a software architecture to facilitate the organic prototype.

12. The computer readable storage medium of claim 9, wherein the programming is further configured to:
walk through the organic prototype, with a developer, for the client;
beta test the organic prototype;
review, by the client and developer, the organic prototype, in a latest version form; and
deploy a final prototype to the client, if the reviewing step is satisfactory.

13. The computer readable storage medium of claim 12, wherein the programming is further configured to:
repeat, as determined necessary, the steps of walking through, beta testing, reviewing, and deploying, thereby updating and improving the organic prototype.

14. The computer readable storage medium of claim 9, wherein the programming is further configured to:
deliver a message to employees within a company or persons within an organization;
educate a group persons on a new policy; and
provide training to new employees or persons.

15. The computer readable storage medium of claim 9, wherein the programming is further configured to:
research and accumulate relative content including one or more taken from the group consisting of: images, documents, policies, tutorials, organizational charts, diagrams, wireframes, surveys, and videos;
divide content into appropriate modules;
collaborate and determine a preferred medium in which to present the content of the module;
estimate hours for labor;
estimate travel expenses; and
estimate equipment rental and expenses.

16. A system for designing and developing a training course responsively as a client makes decisions on requirements and content, the system comprising:
a user interface through which members access the system across a network and for designing and developing a training course responsively as a client makes decisions on requirements and content;
a secure database server consisting of a plurality of database modules for the storage of data pertaining to development of organic prototypes;
wherein the system is configured to:
outline a organic prototype requirements based upon goals a client would like to achieve, thereby setting goals of an organic prototype;
receive client content which client wants included in the organic prototype;
set module objectives, thereby creating an objectives list based upon goals defined in the organic prototype;
create modules, after the modules objectives are set;
visual data, after the modules are determined;
price media production, thereby calculating expenses based on the choices of data visualization;
produce content and media for the organic prototype; and
create the organic prototype.

17. The system of claim 16, wherein the system is further configured to:
incorporate a creative and visual approach as features are added and removed from the organic prototype;
determine a number of modules to be created; and
design a software architecture to facilitate the organic prototype.

18. The system of claim 17, wherein the system is further configured to:
walk through the organic prototype, with a developer, for the client;
beta test the organic prototype;
review, by the client and developer, the organic prototype, in a latest version form; and
deploy a final prototype to the client, if the reviewing step is satisfactory.

19. The system of claim 18, wherein the system is further configured to:
repeat, as determined necessary, the steps of walking through, beta testing, reviewing, and deploying, thereby updating and improving the organic prototype.

20. The system of claim 16, wherein the system is further configured to:
deliver a message to employees within a company or persons within an organization;
educate a group persons on a new policy;
provide training to new employees or persons.
research and accumulate relative content including one or more taken from the group consisting of: images, documents, policies, tutorials, organizational charts, diagrams, wireframes, surveys, and videos;
divide content into appropriate modules;
collaborate and determining a preferred medium in which to present the content of the module;
estimate hours for labor;
estimate travel expenses; and
estimate equipment rental and expenses.
